(19) United States
(12) Patent Application Publication
(10) Pub. No.: US 2018/0165912 A1
(43) Pub. Date: Jun. 14, 2018

(54) Multi-Grid Encoded Lottery Ticket and System

(71) Applicant: IGT GLOBAL SOLUTIONS CORPORATION, Providence, RI (US)

(72) Inventor: Bonnie Vengrofski, Lakeland, FL (US)

(21) Appl. No.: 15/372,749

(22) Filed: Dec. 8, 2016

(51) Int. Cl. G07F 17/32

(52) U.S. Cl. CPC G07F 17/329; G07F 17/3244; G07F 17/3211

(57) ABSTRACT

A multi-grid encoded ticket and system of instant win tickets provides tickets with multiple grids, where each grid represents an independent game, where game play indicia on a first play area is associated with a grid on a second play area and game play indicia on a second play area is associated with a grid on a first play area, and where each ticket can be used individually or by two players interactively, with prizes awarded independently for each game on the ticket.

### BACKGROUND

The present disclosure relates to a lottery ticket product and system, and more particularly to a multi-grid encoded lottery ticket and system.

Multiple play wagering games are provided on certain instant lottery tickets to give players more than one play for a single wager. These games typically employ a playing area having a scratch-off or otherwise removable layer on top of playing indicia that indicate whether the ticket is a winning ticket. Multiple play games in the “match 3” or “slot machine” style can give players several chances to match three symbols or indicia on a line in order to win the prize associated with that line. Some multiple play games have multiple play areas with, for example, a first area having a first game and associated first prize, and a second area having a second or bonus game that is played at the user's option and that can enhance, reduce or even eliminate the first prize.

Grid-based wagering games, such as Bingo or Crossword games, for example, permit players to spend more time on a game before knowing whether or not the game has been won. Some extended play games also provide for second chances or bonus plays based on a single wager.

### BRIEF SUMMARY

In various embodiments, systems, methods and apparatus for an instant win gaming ticket as disclosed herein optionally allow more than one player to play the single ticket at the same time or in turns. The amount won per game is dependent on the results of at least one game represented on the ticket. Multiple games can be won on the same ticket at the same time. The ticket can be embodied as an e-ticket, or as a physical substrate having first and second sides, with one or more game play areas including multiple grids on the first side, with the one or more game play areas optionally covered in a removable material, either partially or entirely. The ticket can be encoded with variable coordinates according to various embodiments, and can include a machine-readable code such that a scanner can assess if the ticket is a winner or not, confirming the outcomes of the play of the ticket games.

### BRIEF DESCRIPTION OF THE SEVERAL VIEWS OF THE DRAWINGS

FIG. 1 is a depiction of a ticket according to embodiments of the present disclosure with unrevealed coordinates.

FIG. 2 is a depiction of a ticket according to embodiments of the present disclosure with revealed coordinates.

FIG. 3 is a depiction of an alternative ticket according to embodiments of the present disclosure with revealed coordinates.

FIG. 4 is a depiction of an alternative ticket according to embodiments of the present disclosure with revealed coordinates.

FIG. 5 is a sample schematic diagram illustrating devices communicating ticket-related information according to aspects of the present disclosure.

### DETAILED DESCRIPTION

One example embodiment of the present disclosure includes a ticket or system of tickets for play of an instant win lottery game, where one or more customers are provided with instant win lottery tickets. Each ticket includes multiple game play areas. A first set of the tickets exists where each ticket in the first set includes game play information indicating that the ticket is a winner of multiple games on the ticket. A second set of the tickets exists where each ticket in the second set includes game play information indicating that the ticket is a winner of the first or the second game, but not both games. A third set of the tickets exists where each ticket in the third set includes game play information indicating that the ticket is not a winner of any games.

When a player (e.g., customer) presents a ticket of the first or second set of tickets for redemption, the player may be given the appropriate cash prize. Presentation of the ticket can be at a physical retail location, for example, whereby the ticket is presented to a human clerk, who can operate a lottery transaction device to confirm whether the ticket is a prize winner. In various embodiments, a scanning device such as a barcode scanner can be employed with the lottery transaction device, such that the scanning device scans a code to validate the winning ticket. In alternative embodiments, the player presents the winning ticket to a self-service terminal having a code reading device communicatively coupled thereto. The code reading device can read the barcode on the ticket to confirm the ticket is a winner, and winnings can be paid either directly to the player in the form of cash, or by credit. Credit can include a credit to an electronic account held by the player, or through the issuance of a physical device, such as a physical voucher, or by crediting of a physical device, such as a player card, for example.

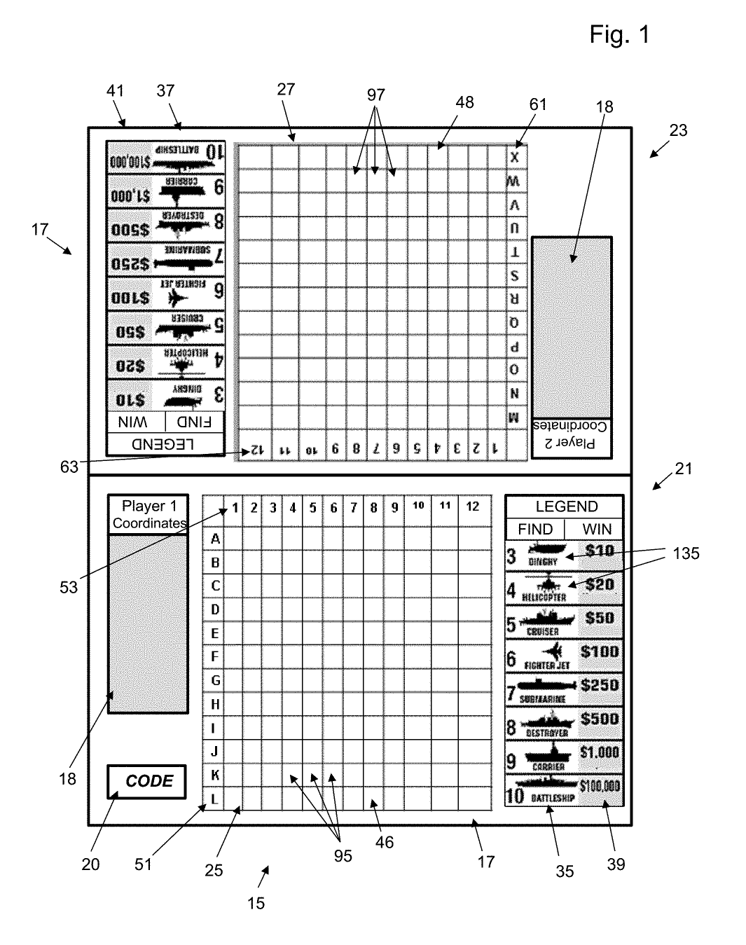

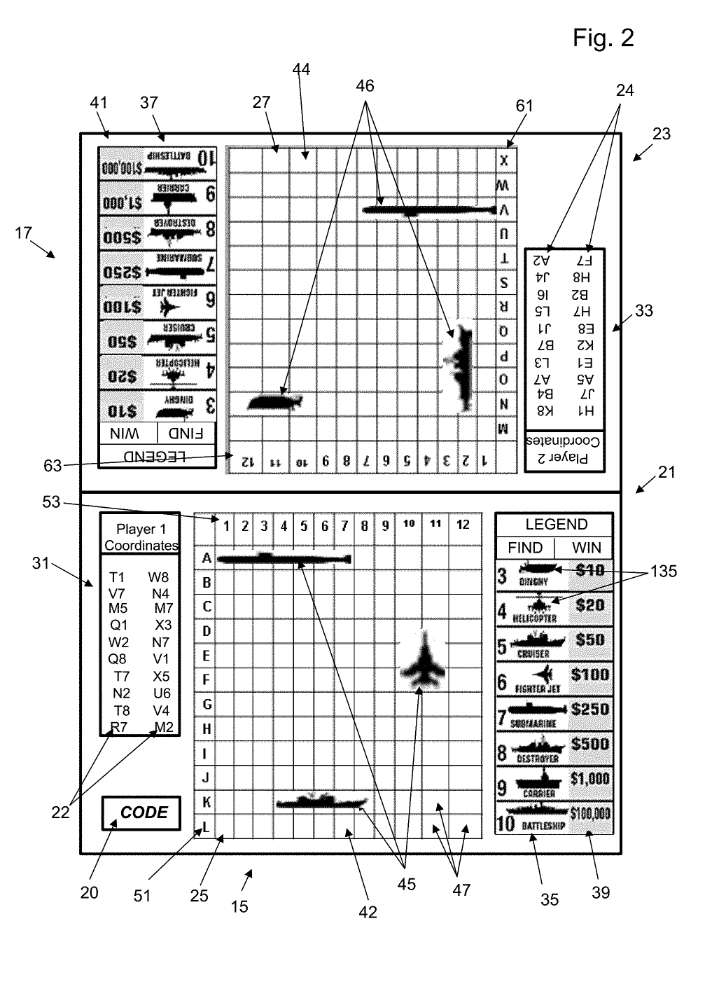

Some other example embodiments can include a system for facilitating the operation of a game of chance involving one or more players, wherein the system includes a plurality of pre-printed instant win lottery tickets, optionally with removable coverings on a portion or all of one or more game play areas on each ticket. FIGS. 1 and 2 illustrate examples of such a ticket 15. As shown therein, ticket 15 has a front side 17 including first 21 and second 23 game play areas, with a first grid 25 indicated on the first segment 21 and oriented in a first direction, and with a second grid 27 indicated on the second segment 23 and oriented in a second direction that is upside down from the first direction. The upside down orientation of the play areas facilitates play by two players, who may be facing each other and can thereby see his or her own playing area in the upright orientation without having to rotate the ticket. Each grid 25, 27 comprises a plurality of rows and a plurality of columns, with a matrix of grid spaces therein, with each grid space (e.g., 95 in grid 25 and 97 in grid 27) being defined at a point of intersection between one of the at least two rows and one of the at least two columns of a respective grid 25, 27. The ticket 15 further has first 31 and second 33 sets of indicia pairs or call coordinates, and first 35 and second 37 sets of prize symbols, with the first set of indicia pairs 31 and first set of prize symbols 35 appearing on the first segment 21 in the first direction, and with the second set of indicia pairs 33 and second set of prize symbols 37 appearing on the second segment 23 in the second direction. The prize symbols 35, 37 can be paired with corresponding prizes 39, 41, respectively. In various embodiments, each prize symbol of the first set of prize symbols is associated with a respective and independent number of grid spaces, such that no two prize symbols within the first set of prize symbols is associated with the same number of grid spaces. Similarly, in various embodiments, each prize symbol of the second set of prize symbols is associated with a respective and independent number of grid spaces, such that no two prize symbols within the second set of prize symbols is associated with the same number of grid spaces. A code 20 can be placed on each ticket 15 to facilitate activation and validation functions as described elsewhere herein.

As further shown in FIGS. 1 and 2, the first grid 25 includes a plurality of first grid spaces 95, and the second grid 27 includes a plurality of second grid spaces 97. Further, each indicia pair 22 in the indicia pair set 31 in the first game play area 21 corresponds to a respective grid space (e.g., 97) for corresponding alphanumeric indicia in the second grid 27. Also, each indicia pair 24 in the indicia pair set 33 in the second game play area 23 corresponds to a respective grid space (e.g., 95) for corresponding alphanumeric indicia in the first grid 25. Thus, as shown in FIG. 2, the coordinates H1, K8, J7, B4, etc. from the second set 33 of indicia pairs correspond to respective grid locations in the first grid 25, and the coordinates T1, W8, V7, N4, etc., from the first set 31 of indicia pairs correspond to respective grid locations in the second grid 27.

The indicia pair sets 31, 33, grids 25, 27, prize symbols 35, 37 and prizes 39, 41 can be considered game play information, collectively or independently. Game play information can also be provided in the form of a first arrangement 42 of symbols and blank spaces within the first grid 25 and a second arrangement 44 of symbols and blank spaces within the second grid 27. Such arrangements 42, 44 are shown in FIG. 2, and can be covered by a respective removable covering 46, 48, as shown in FIG. 1. By way of example, in FIG. 2, arrangement 42 includes multiple target symbols 45 and blank spaces 47 within the grid 25.

As further shown in FIGS. 1 and 2, the first grid 25 includes alphanumeric indicia 51, 53 as headers of respective rows and columns within the first grid 25. In the example shown, indicia 51 comprise individual letters at the head of each row, and indicia 53 comprise individual numbers at the head of each column. The second grid 27 includes similar alphanumeric indicia 61, 63. Combining one of the indicia 51 with one of the indicia 53 results in an alphanumeric pair, and combining one of the indicia 61 with one of the indicia 63 results in another alphanumeric pair. It will be appreciated that, for purposes of the present disclosure, the term “alphanumeric” can mean a number (e.g., “11”), a letter (e.g., “A”), or a letter-number combination (e.g., “A11”). Further, the “alphanumeric pair” can mean, without limitation, a letter-number combination, a letter-letter combination, a number-number combination or other indicia (e.g., symbol, flag, icon) combination, where the combination includes a first digit and a second digit, and wherein the “digit” can be represented as a single marking (e.g., “2”) or multiple markings (e.g., “12”). For example, FIGS. 1 and 2 illustrate that each of the coordinates corresponding to spaces in the first 25 and second 27 grids is a letter-number combination. Further, while the first 25 and second 27 grids share a common number digit sequence (i.e., the sequence 1-to-12 is the same in both grids 25, 27), the letter digit sequence (letters A-L) associated with the first grid 25 is different from the letter digit sequence (letters M-X) associated with the second grid 27. In this way, the potential for confusion is minimized, and a player will not mistakenly scratch off coordinate pairs in a grid in the same play area as the indicia pair set, for example.

The indicia pairs 22, 24 can be covered by a removable material 18, such as a scratch-off material, for example, as will be understood. During play, in various embodiments, a first player can scratch off one or more indicia pairs 22 and call the revealed indicia out verbally to a second player. The second player, viewing second grid 27, can then scratch off the grid coordinate in second grid 27 corresponding to the called indicia pair 22. For example, if the first player calls “T1”, then the second player scratches off the grid area corresponding to the intersection of the “T” row with the “1” column. In the example of FIG. 2, scratching off “T1” would not reveal any portion of a target symbol 46 in grid 27. Optionally, the second player can inform the first player as to whether the called indicia pair resulted in a “hit” or “miss” of a target symbol. The game play can continue with the second player calling a revealed indicia pair 24 from indicia pair set 33 to the first player, wherein the first player can then remove the covering over the called indicia pair on the first grid 25 to determine if a portion of a target symbol 45 is revealed on grid 25.

In various embodiments, as shown in FIGS. 1 and 2, the indicia pair sets 31, 33 and the grid arrangements 42, 44 are pre-determined and pre-printed on the lottery ticket 15. Upon checking the second grid 27 for all of the indicia pair 22 shown in the first set 31, the system can operate such that the first player wins a prize 41 associated with any fully revealed symbol from the symbols 37 associated with the second grid. Similarly, upon checking the first grid 25 for all of the indicia pair 24 shown in the second set 33, the system can operate such that the second player wins a prize 39 associated with any fully revealed symbol from the symbols 35 associated with the first grid 25. The system can operate such that, if a single coordinate pair corresponding to a called indicia pair reveals a symbol or a portion of a symbol, the ticket is a winner. The system can further operate such that multiple coordinate pairs corresponding to multiple called indicia pairs must reveal a symbol covering more than one grid space in order for the ticket to be a winner. For instance, each of the target symbols 45 on grid 25 covers more than one grid space, and in various embodiments, the full target symbol must be uncovered in order for the ticket to be a winning ticket such that a prize is to be awarded. In a specific embodiment, the full target symbol encompasses grid spaces in more than one row and more than one column, requiring that indicia pairs matching all of the corresponding grid spaces in more than one row and more than one column associated with the target symbol be uncovered in order for a prize to be awarded. Further, in various embodiments, each prize symbol (e.g., 135 in FIGS. 1 and 2) of each set (e.g., first set 35) of prize symbols is associated with a respective and independent number of grid spaces, such that no two prize symbols within a set of prize symbols is associated with the same number of grid spaces. For example, as shown in FIG. 2, each of the prize symbols 45 covers a different number of grid spaces. It will be appreciated that a single player can play both play areas 21, 23 on a given ticket.

In various embodiments, a system is provided with a plurality of tickets, wherein a first subset of the tickets is printed such that each ticket in the first set includes game play information indicating that the ticket is a winner of both games shown in play areas 21, 23 on the ticket, i.e., the game associated with grid 25 and the game associated with grid 27. Further, a second subset of the tickets can be printed such that each ticket in the second set includes game play information indicating that the ticket is a winner of either the game shown in play area 21 or the game shown in play area 23, but not both. For example, one or more full symbols may be matched in the game associated with grid 25 or the game associated with grid 27, but not both. A third subset of the tickets can be printed such that each ticket in the third set includes game play information indicating that the ticket is not a winner of either game shown in play area 21 or play area 23. It will be appreciated that the plurality of tickets in the system can have different subsets than those described above, including, for example, a subset where the game associated with the first grid 25 is a winner and a different subset where the game associated with the first grid 25 is not a winner.

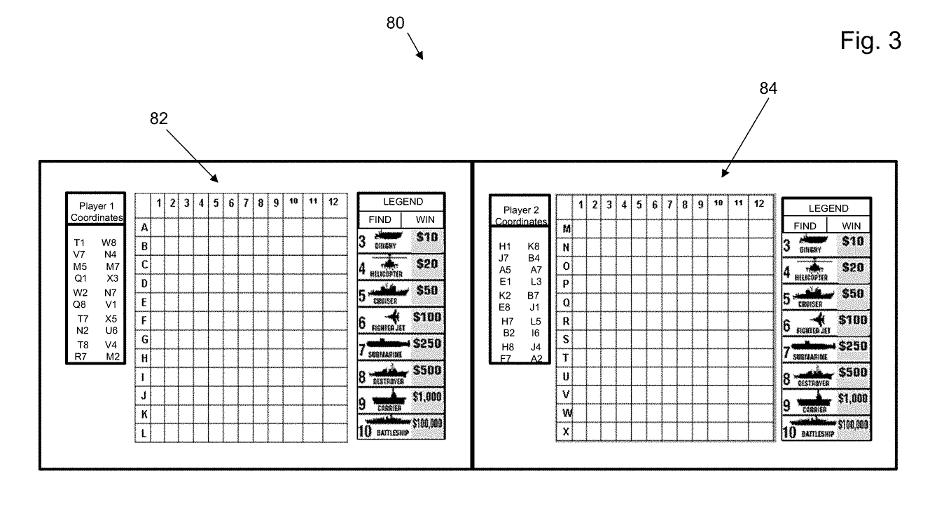

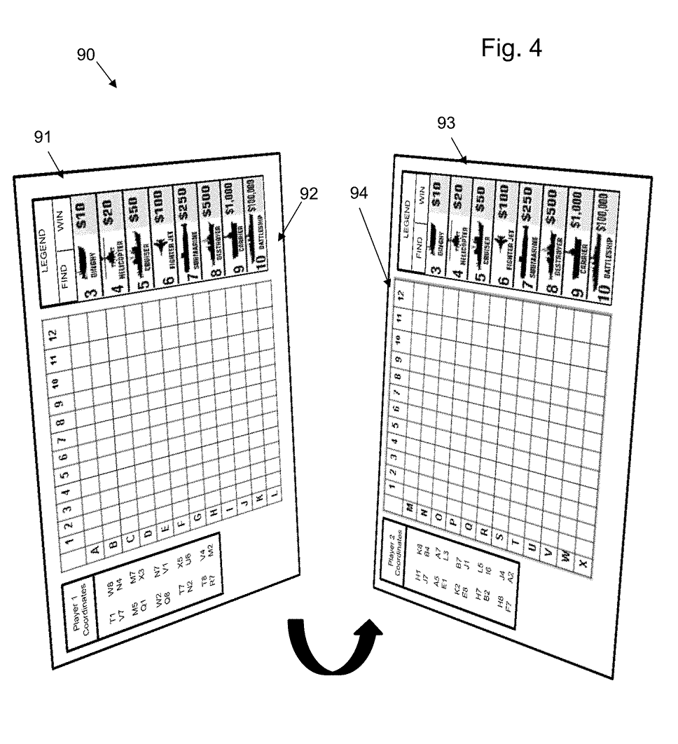

FIG. 3 illustrates an alternative embodiment of a ticket 80 according to the present disclosure, wherein the first game play area 82 is adjacent the second game play area 84. Such an arrangement can facilitate play by a single player, or play be two players who are positioned adjacent each other and not across from each other, for example. FIG. 4 illustrates an alternative embodiment of a ticket 90 according to the present disclosure, wherein the first game play area 92 is on a front side 91 of the ticket 90, and the second game play area 94 is on the back side 93 of the ticket 90. Such an arrangement can facilitate play by one or more players, assisting in avoiding confusion as to which grid is to be associated with which indicia set, for example.

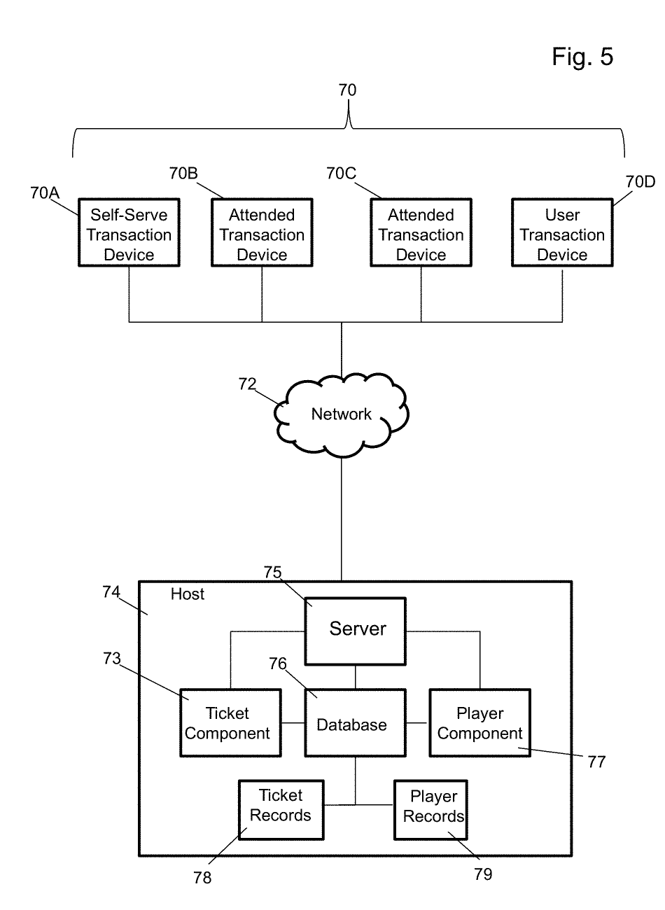

According to various embodiments, a game play ticket as described herein can be purchased as a physical ticket purchased at a physical retail establishment, such as a convenience store, for example. The establishment can include one or more point-of-sale lottery transaction devices for consummating the sale. As shown in FIG. 5, exemplary lottery transaction devices 70A-70D are shown as being communicatively coupled over a network 72 to a host device 74. The host 74 can contain a server 75, which may be a single central server, a plurality of distributed servers, or any other example embodiment capable of facilitating the components of host 74. The server 75 may include and/or be in communication with a database 76 to facilitate operation of the server 75 and to facilitate necessary and desired logging of system events. The database 76 may be used to store player and ticket identification information. The database 76 may store information such as what instant prizes are associated with what identifying information associated with a ticket and transmitted to the server 75 (e.g., a barcode on the ticket transmitted to the server 75 which looks up what prizes that are associated with that ticket). The network 72 can be a private network or a public network, such as the Internet, for example. Various approaches can be used by the player for providing consideration for the ticket. For example, the player can be a registered player with an electronic wallet and/or account, such that upon providing relevant credentials (e.g., a card, biometric information) at the transaction device, the player can authorize the account to be debited in the amount of the ticket(s) purchased. The host 74 can record relevant information about the purchase transaction, including entrant data, sales data, ticket information, ticket redemption information, one or more machine-readable or human-readable codes (e.g., 20) on each ticket, winner data, and assorted other relevant data, which may be logged in a database 76 in communication with the host 74 and used by example embodiments. It will be appreciated that there may be a plurality of terminals in the establishment which are configured to process payments and issue tickets to players, as well as to receive the instant lottery tickets in the first or second set of tickets for redemption. Optionally, the terminals may be self-serve automated terminals (e.g., 70A), may be staffed by an agent (e.g., 70B, 70C) or may be user devices (e.g., 70D). The user devices 70D may be, for example, mobile communication devices, PDAs, notebook computers, tablets or personal computers. The player may use the user device 70D as a form of terminal to purchase instant lottery tickets. Since the clerk-attended terminal 70B, 70C or self-serve terminal 70A may be loaded with printed tickets or have a proprietary printing system, the user device 70D may differ in this respect, and may be limited to virtual tickets. The terminals may redeem the first or second set of lottery tickets for cash prizes, which can be issued directly to the player redeeming the ticket or credited to a player account associated with the redeemed ticket.

The host 74 may be responsible to provide redemption information, prize information, and other information to the terminals 70. Optionally, the terminals, host, and tickets are designed with verification, validation, and/or anti-cheating mechanisms to ensure game integrity. In the embodiments with a computer readable code 20 (e.g., barcode and/or human readable code) on the ticket, this code may be used to validate the ticket, or for a machine to read the contents of the ticket. The example embodiment may also include security and/or anti-tampering technologies. The host 74 may be configured, responsive to the tender of a lottery ticket in the first or second subsets for redemption at a terminal, to transmit an indication to the terminal that the ticket should be redeemed for an instant win prize.

Example embodiments may include a host 74 for a system for facilitating the play of a game of chance. The host 74 may have a network interface configured to provide networked communication with one or a plurality of lottery ticket terminals (shown generally at 70 in FIG. 5). The host may have an instant ticket component 73 in communication with the network interface configured to facilitate, among other things, the redeeming of instant win lottery tickets when appropriate. The instant ticket component 73 can also, among other things, generate electronic tickets embodying the elements of the tickets described herein, and store ticket outcomes associated with specific tickets and machine- and/or human-readable codes.

In one example embodiment, a computer readable medium is provided comprising computer readable instructions to perform the methods for facilitating play of a game of chance described herein.

In operation, a player may request an instant ticket at a terminal. One or more of the instant tickets can be in stock at the retailer terminal, such as in a pack of tickets previously distributed to the terminal, and codes associated with each ticket may be stored at the host 74 along with ticket information indicating, for example, whether the ticket is a winning ticket and the pre-determined prize associated with the ticket. In various embodiments, a purchased ticket can be associated with the purchasing player through player identification provided at the time of purchase, such as through a player associating the purchase with a player account, for example. Such association can be recorded and stored via player component 77 and database 76, for example. The purchase request from the player can be made by verbally indicating to an agent operating an agent-operated lottery terminal the desire to purchase an instant ticket. It may also include a player entering data inputs on a self-service lottery ticket terminal or kiosk, such as an IGT lottery ticket terminal available from IGT Global Solutions Corporation of Providence, R.I. Alternatively, the entry of the request to obtain a ticket may be carried out on a home computer, by a user navigating to an appropriate website and requesting the online purchase of an instant lottery ticket (e.g., with a personal computer, or mobile device).

The terminal may receive the player request to obtain the instant lottery ticket. The player may be required to pay for the instant lottery ticket prior to obtaining the ticket. The payment may be received by the terminal. This may be a player handing a terminal operator cash or some other form of accepted payment. Alternatively, the receipt of payment may be from a player providing a form of payment at the terminal (e.g., entering credit card information on a home computer, depositing cash into a self-serve vending machine, swiping a credit, debit, or pre-paid card, or any other conventional approach for transfer of funds). Next, the terminal may report the ticket purchase to the host and request activation of the ticket. The data transmission, as well as the data required to activate the ticket is transmitted to the host. The data transmissions can be of any variety, such as, for example, a synchronous protocol with multiple messages, asynchronous packet sent to an online transaction processing system and response, automated email queries, transfer of secure tokens, communications through proxies, or any other known transmission protocol or method.

The host 74 may then log the purchase information, ticket information, or any other assortment of relevant data associated with the sale of an instant win ticket in database 76, which can include relevant ticket records 78 and player records 79, among other records. The host 74 will also receive the activation request information, and will send the terminal (any of 70A-D) an activation confirmation if activation was successful. The host 74 may also send an error if activation was not successful so that the terminal may select a different ticket, and the terminal and host may repeat the steps for that ticket. Once the terminal has received that activation confirmation, the terminal will be ready to provide the instant ticket to the player. Other example embodiments in addition or alternative to this, may sell tickets that do not require activation. For these example embodiments, the terminal may optionally report the purchase, but need to request or receive an activation for the ticket. In this respect, the tickets may be sold without the use of a terminal device until redemption occurs. The instant ticket received by the player can be a physical ticket handed to a customer at a retail lottery ticket location, or may be a printable graphic on a user device (e.g., personal computer). In various example embodiments, the player may be given an instant ticket of the “scratch off” variety. A scratch off ticket is one in which various information is concealed by an opaque cover the player may remove, such as by scratching or peeling the cover off of the ticket, or by hitting a button or performing a virtual “scratch off” with an input device such as a mouse or touchpad, for example.

Whether played by one or more players, the purchased ticket can be presented for redemption if it is a winning ticket. Generally, if the ticket indicates no prize was won, the player would not present it, but this does not preclude the terminal or host being able to identify a ticket with no associated prize. The instant ticket may be received for redemption by the terminal (e.g., 70A, 70B, 70C, 70D). The terminal may then request validation, by sending the relevant data to the host 74. In various embodiments, the terminal scans, reads or otherwise receives information associated with a code 20 on the ticket, whether machine-readable or human-readable, sends relevant information to the host 74, and the host 74 can then validate the ticket and determine what prizes are associated with that ticket. If the ticket is valid, the host 74 sends back a validation to the terminal 70A, 70B, 70C or 70D. If the ticket is invalid, the host 74 may return an error. Host operations regarding the purchase, validation and redemption of the ticket can occur through ticket component 73 using data stored in ticket database records 78, for example. If the ticket is an instant prize winner, the host 74 may inform the terminal if an instant prize is required. Instant prizes may be of any type where the value is immediately determinable, such as cash, credits, prizes, or a free instant win lottery ticket, for example. If the instant ticket is an instant prize winner, the terminal (or terminal operator) may issue the player the appropriate instant prize.

It will be appreciated that tickets according to the present disclosure can include instructions on how to play the game printed on the ticket substrate. These instructions include information indicating how to determine what prize, if any, the example ticket qualifies for. The ticket also may include information that indicates the cost of the ticket, the name of the instant win lottery game, and prizes available in the game, for example. The ticket may also have a barcode and/or serial number (e.g., represented at 20 in FIGS. 1 and 2) printed on the front or back of the ticket, which may uniquely identify the ticket and include relevant information about the ticket, including information required to validate the ticket when it is presented for redemption. This barcode and/or serial number may also implement anti-tamper measures, and the ticket may contain additional security measures. The ticket may also have other relevant information such as the date the ticket was generated, the agent and/or terminal the ticket was generated on, and a range of validation or security measures to prevent cheating.

It will be appreciated that all of the disclosed methods and procedures herein can be implemented using one or more computer programs or components. These components may be provided as a series of computer instructions on any conventional computer-readable medium, including RAM, SATA DOM, or other storage media. The instructions may be configured to be executed by a processor which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A system, comprising:
a plurality of tickets, each ticket comprising a front side, a back side and first and second game play areas, with a first grid indicated on the first game play area, and with a second grid indicated on the second game play area, with each ticket further comprising first and second sets of indicia pairs and first and second sets of prize symbols, with the first set of indicia pairs and first set of prize symbols appearing on the first game play area, and with the second set of indicia pairs and second set of prize symbols appearing on the second game play area;
game play information within the first grid on a first subset of the plurality of tickets indicating that a prize symbol in the first set of prize symbols has been matched by a plurality of indicia pairs within the second set of indicia pairs; and
game play information within the second grid on the first subset of the plurality of tickets indicating that a prize symbol in the second set of prize symbols has been either matched or not matched by a plurality of indicia pairs within the first set of indicia pairs.

2. The system of claim 1, wherein the first grid comprises a plurality of first grid spaces, with each of the first grid spaces corresponding to a respective coordinate pair associated with the second set of indicia, and wherein the second grid includes a plurality of second grid spaces, with each of the second grid spaces corresponding to a respective coordinate pair associated with the first set of indicia.

3. The system of claim 2, wherein the game play information within the first grid comprises a target symbol displayed on a plurality of first grid spaces.

4. The system of claim 2, wherein the first set of prize symbols comprises symbols associated with a plurality of grid spaces within the first grid.

5. The system of claim 4, wherein each prize symbol of the first set of prize symbols is associated with a respective and independent number of grid spaces, such that no two prize symbols within the first set of prize symbols are associated with the same number of grid spaces.

6. The system of claim 1, wherein the first game play area is on the front side of each ticket, and the second game play area is on the back side of each ticket.

7. The system of claim 1, wherein the first and second game play areas are on the front side of each ticket.

8. The system of claim 7, wherein the second game play area is oriented upside down from the first game play area on each ticket.

9. A system, comprising:
a plurality of tickets, each ticket comprising a front side comprising first and second game play areas, with a first grid indicated on the first game play area and oriented in a first direction, and with a second grid indicated on the second game play area and oriented in a second direction that is upside down from the first direction, with each ticket further having first and second sets of indicia pairs and first and second sets of prize symbols, with the first set of indicia pairs and first set of prize symbols appearing on the first game play area in the first direction, and with the second set of indicia pairs and second set of prize symbols appearing on the second game play area in the second direction;
game play information within the first grid on a first subset of the plurality of tickets indicating that a prize symbol in the first set of prize symbols has been matched by a plurality of indicia pairs within the second set of indicia pairs; and
game play information within the first grid on a second subset of the plurality of tickets indicating that a prize symbol in the first set of prize symbols has not been matched by a plurality of indicia pairs within the second set of indicia pairs.

10. The system of claim 9, wherein the indicia pairs of each ticket comprise an alphanumeric pair.

11. The system of claim 9, wherein the first grid comprises a plurality of first grid spaces, with each of the first grid spaces corresponding to a respective coordinate pair associated with the second set of indicia, and wherein the second grid comprises a plurality of second grid spaces, with each of the second grid spaces corresponding to a respective coordinate pair associated with the first set of indicia.

12. The system of claim 11, wherein each of the first grid coordinates and each of the second grid coordinates comprises a pair of alphanumeric digits, and wherein the alphanumeric digits of the first and second grid coordinate pairs comprise a common digit sequence.

13. The system of claim 12, wherein the alphanumeric digits of the first grid coordinates comprises a digit sequence that is different from the alphanumeric digits of the second grid coordinates.

14. A lottery game ticket, comprising:
a ticket substrate;
a first game play area displayed on the substrate, with the first game play area comprising a first grid having at least two rows, at least two columns and a matrix of individual grid spaces, wherein each grid space of the first grid is defined by a first grid coordinate pair at a point of intersection between one of the at least two rows and one of the at least two columns of the first grid, wherein the first grid further comprises at least one first grid target symbol displayed across multiple grid spaces of the first grid, and wherein the first game play area further comprises a first set of indicia pairs;
a second game play area displayed on the substrate, with the second game play area comprising a second grid having at least two rows, at least two columns and a matrix of individual grid spaces, wherein each grid space of the second grid is defined by a second grid coordinate pair at a point of intersection between one of the at least two rows and one of the at least two columns of the second grid, wherein the second grid further comprises at least one second grid target symbol displayed across multiple grid spaces of the second grid, and wherein the first game play area further comprises a second set of indicia pairs; and
wherein the first set of indicia pairs of the first game play area comprises indicia matching a second grid coordinate pair of the second grid, and wherein the second set of indicia pairs of the second game play area comprises indicia matching a first grid coordinate pair of the first grid.

15. The ticket of claim 14, wherein each of the first and second grids comprises a plurality of coordinate pairs, wherein each coordinate pair comprises a pair of alphanumeric digits, and wherein the alphanumeric digits of the first and second grid coordinate pairs include a common digit sequence.

16. The ticket of claim 15, wherein the alphanumeric digits of the first grid coordinate pairs comprise a digit sequence that is different from the alphanumeric digits of the second grid coordinate pairs.

17. The ticket of claim 14, wherein the first game play area comprises a first set of prize symbols, and the second game play area comprises a second set of prize symbols, and further comprising game play information within the first grid indicating that a prize symbol in the first set of prize symbols has been matched by a plurality of indicia pairs within the second set of indicia pairs.

18. The ticket of claim 17, wherein each prize symbol of the first set of prize symbols is associated with a respective and independent number of grid spaces, such that no two prize symbols within the first set of prize symbols is associated with the same number of grid spaces.

19. The ticket of claim 14, wherein the ticket substrate has a front side and a back side, and wherein the first and second game play areas are on the front side of the ticket.

20. The ticket of claim 19, wherein the second game play area is oriented upside down from the first game play area on the ticket.
